(19) United States
(12) Patent Application Publication
(10) Pub. No.: US 2026/0156006 A1
(43) Pub. Date: Jun. 4, 2026

(54) CONTROL METHOD, SYSTEM, AND RECORDING MEDIUM

(71) Applicant: Panasonic Intellectual Property Management Co., Ltd., Osaka (JP)

(72) Inventors: Ayaka NAKASAKA, Osaka (JP); Naohisa NISHIDA, Kanagawa (JP); Kakuya YAMAMOTO, Hyogo (JP); Yuuki HIROSE, Osaka (JP)

(21) Appl. No.: 19/459,546

(22) Filed: Jan. 26, 2026

Related U.S. Application Data
(63) Continuation of application No. PCT/JP2024/026558, filed on Jul. 25, 2024.

(51) Int. Cl. H04L 9/00

(52) U.S. Cl. CPC H04L 9/50

(57) ABSTRACT

A control method is performed by a control device that manages one or more blockchains and includes: determining, based on a first rule, whether to delete one or more first blockchains including first data among the one or more blockchains; and when the one or more first blockchains are determined to be deleted, terminating, at a predetermined timing, functions of the one or more first blockchains including the first data among the one or more blockchains managed by the control device.

### CROSS REFERENCE TO RELATED APPLICATIONS

This is a continuation application of PCT International Application No. PCT/JP2024/026558 filed on July 25, 2024, designating the United States of America, which is based on and claims priority of U.S. Provisional Patent Application No. 63/530511 filed on August 3, 2023. The entire disclosures of the above-identified applications, including the specifications, drawings and claims are incorporated herein by reference in their entirety.

### FIELD

The present disclosure relates to control methods, systems, and recording media.

### BACKGROUND

Patent Literature (PTL) 1 discloses a management device that operates a distributed ledger while taking into consideration the life cycle of the distributed ledger. Specifically, the management device deletes a distributed ledger whose registered data have all reached the end of life cycles thereof.

### Citation List

### Patent Literature

PTL 1: International Publication No. 2021/176598

### SUMMARY

### Technical Problem

However, in the technique disclosed in PTL 1, there is a possibility that a portion of the distributed ledger may be left behind; this means that the data to be deleted may not be deleted from the network.

The present disclosure provides a control method, etc., in which the data to be deleted can be deleted from the network.

### Solution to Problem

A control method according to an aspect of the present disclosure is performed by a control device that manages one or more blockchains, and includes: determining, based on a first rule, whether to delete one or more first blockchains including first data among the one or more blockchains; and when the one or more first blockchains are determined to be deleted, terminating, at a predetermined timing, functions of the one or more first blockchains including the first data among the one or more blockchains managed by the control device.

A system according to an aspect of the present disclosure includes a control device that manages one or more blockchains, and includes: a processor; and memory. Using the memory, the processor: determines, based on a first rule, whether to delete one or more first blockchains including first data among the one or more blockchains; and when the one or more first blockchains are determined to be deleted, terminates, at a predetermined timing, functions of the one or more first blockchains including the first data among the one or more blockchains managed by the control device.

Note that these general and specific aspects may be implemented using a system, a device, an integrated circuit, a computer program, or a computer-readable recording medium such as compact disc read-only memory (CD-ROM), or any combination of systems, devices, integrated circuits, computer programs, and recording media.

### Advantageous Effects

With the control method, etc., according to the present disclosure, the data to be deleted can be deleted without being left behind on a blockchain.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram for describing the outline of a system according to an embodiment.

FIG. 2 is a conceptual diagram of the data structure of a blockchain managed by a permissioned blockchain system according to an embodiment.

FIG. 3 is a diagram illustrating an example of the configuration of a terminal according to an embodiment.

FIG. 4 is a diagram illustrating an example of the configuration of a management server according to an embodiment.

FIG. 5 is a sequence chart illustrating a first portion of an example of the operation of a system according to an embodiment.

FIG. 6 is a sequence chart illustrating a second portion of an example of the operation of a system according to an embodiment.

FIG. 7 is a sequence chart illustrating a third portion of an example of the operation of a system according to an embodiment.

FIG. 8 is a diagram illustrating an example of a smart contract according to an embodiment.

FIG. 9 is an explanatory diagram illustrating the data structure of a blockchain.

FIG. 10 is an explanatory diagram illustrating the data structure of transaction data.

FIG. 11 is an explanatory diagram illustrating transaction data related to execution of a smart contract.

FIG. 12 is an explanatory diagram illustrating processing related to execution of a smart contract.

### DESCRIPTION OF EMBODIMENT

A control method according to a first aspect of the present disclosure is performed by a control device that manages one or more blockchains, and includes: determining, based on a first rule, whether to delete one or more first blockchains including first data among the one or more blockchains; and when the one or more first blockchains are determined to be deleted, terminating, at a predetermined timing, functions of the one or more first blockchains including the first data among the one or more blockchains managed by the control device.

Thus, when it is determined that the one or more first blockchains are to be deleted, the control device terminates the functions of all the blockchains under management, and the data to be deleted can be practically deleted from the network.

A control method according to a second aspect of the present disclosure is the control method according to the first aspect and further includes: generating first transaction data including a first smart contract for the determining; and storing the first transaction data into the one or more blockchains. The determining is performed according to the first smart contract.

Thus, whether to delete the one or more first blockchains is determined according to the first smart contract, meaning that the determination based on the first rule can be automatically performed. Furthermore, since the contract code of the first smart contract is stored in the one or more blockchains and open to the public, the logic in deleting the one or more first blockchains can be verified. Therefore, the fairness of the determination can be ensured.

A control method according to a third aspect of the present disclosure is the control method according to the first aspect or the second aspect in which the first rule is to delete the one or more first blockchains when a first condition is satisfied, the first condition being that a data size or processing load-related parameter of the one or more first blockchains exceeds a first threshold value.

Accordingly, it is possible to delete a blockchain whose data size or processing load-related parameter exceeds the first threshold value.

A control method according to a fourth aspect of the present disclosure is the control method according to the second aspect in which the determining is performed when a second condition is satisfied, the second condition being that a data size or processing load-related parameter of the one or more first blockchains exceeds a second threshold value.

Accordingly, whether to delete the one or more first blockchains can be determined at the timing when the data size or processing load-related parameter exceeds the second threshold value.

A control method according to a fifth aspect of the present disclosure is the control method according to the first aspect in which the predetermined timing occurs when a third condition is satisfied, the third condition being that a data size or processing load-related parameter of the one or more first blockchains exceeds a third threshold value.

Accordingly, the functions of all the blockchains managed by the control device can be terminated at the timing when the data size or processing load-related parameter exceeds the third threshold value.

A control method according to a sixth aspect of the present disclosure is the control method according to any one of the first aspect to the fifth aspect and further includes: determining specific data from the one or more blockchains based on a second rule; and transferring the specific data to a predetermined device before the predetermined timing. The second rule is to determine data with a specific attribute as the specific data.

Thus, among data that becomes unavailable on blockchains when the functions of the one or more blockchains are terminated, the specific data to be saved is transferred to the predetermined device, meaning that even when the functions of the one or more blockchains are terminated, the specific data can be used.

A control method according to a seventh aspect of the present disclosure is the control method according to the sixth aspect in which the predetermined device controls another blockchain different from the one or more blockchains, and the specific data transferred is stored into the other blockchain.

Thus, among data that becomes unavailable on blockchains when the functions of the one or more blockchains are terminated, the specific data to be saved is stored into another blockchain, meaning that even when the functions of the one or more blockchains are terminated, the specific data can be used by accessing the other blockchain.

A control method according to an eighth aspect of the present disclosure is the control method according to the seventh aspect in which a total number of a plurality of nodes that control the other blockchain is greater than or equal to a fourth threshold value or a block height of the other blockchain is greater than or equal to a fifth threshold value.

Accordingly, a blockchain with higher reliability can be determined as the transfer destination.

A control method according to a ninth aspect of the present disclosure is the control method according to the sixth aspect in which a database is stored in the predetermined device, and the specific data transferred is stored into the database.

Thus, among data that becomes unavailable on blockchains when the functions of the one or more blockchains are terminated, the specific data to be saved is stored into a database, meaning that even when the functions of the one or more blockchains are terminated, the specific data can be used by accessing the database.

A control method according to a tenth aspect of the present disclosure is the control method according to the sixth aspect in which each of the one or more blockchains is a consortium blockchain in which a plurality of organizations participate, each of the one or more first blockchains is a blockchain determined to be deleted for a first organization among the plurality of organizations to withdraw from the one or more blockchains, when a total number of remaining organizations excluding the first organization among the plurality of organizations is greater than or equal to a sixth threshold value, a device that manages another blockchain different from the one or more blockchains is determined as the predetermined device, and when the total number of remaining organizations is less than the sixth threshold value, a device in which a database is stored is determined as the predetermined device.

Accordingly, when the total number of organizations is greater than or equal to the sixth threshold value, the specific data is stored into another blockchain, which allows the specific data to be continuously managed on a consortium blockchain. When the total number of organizations is less than the sixth threshold value, the specific data is stored into a database, which allows the specific data to be managed in the database.

A control method according to an eleventh aspect of the present disclosure is the control method according to any one of the sixth aspect to the tenth aspect and further includes: generating second transaction data including a second smart contract for the determining of the specific data; and storing the second transaction data into the one or more blockchains. The determining of the specific data is performed according to the second smart contract.

Thus, the specific data can be automatically determined according to the second smart contract. Furthermore, since the contract code of the second smart contract is stored in the one or more blockchains and open to the public, the logic in determining the specific data can be verified.

A control method according to a twelfth aspect of the present disclosure is the control method according to any one of the sixth aspect to the eleventh aspect and further includes: generating third transaction data including a third smart contract for the determining of the predetermined device; and storing the third transaction data into the one or more blockchains. The predetermined device is determined by executing the third smart contract.

Thus, the predetermined device can be automatically determined according to the third smart contract. Furthermore, since the contract code of the third smart contract is stored in the one or more blockchains and open to the public, the logic in determining the predetermined device can be verified.

A control method according to a thirteenth aspect of the present disclosure is the control method according to any one of the first aspect to the twelfth aspect and further includes: after the terminating, recording information indicating that functions of the one or more blockchains have been terminated; and storing the information into a blockchain for records that is different from the one or more blockchains.

When the functions of the one or more blockchains are terminated, the functions of the one or more blockchains cannot be used. Therefore, the information indicating that the functions of the one or more blockchains have been terminated is stored into the blockchain for records, which allows reference to the fact that the functions of the one or more blockchains have been terminated.

A system according to a fourteenth aspect of the present disclosure includes a control device that manages one or more blockchains, and includes: a processor; and memory. Using the memory, the processor: determines, based on a first rule, whether to delete one or more first blockchains including first data among the one or more blockchains; and when the one or more first blockchains are determined to be deleted, terminates, at a predetermined timing, functions of the one or more first blockchains including the first data among the one or more blockchains managed by the control device.

Thus, when it is determined that the one or more first blockchains are to be deleted, the control device included in the system terminates the functions of all the blockchains under management, and the data to be deleted can be practically deleted from the network.

A recording medium according to a fifteenth aspect of the present disclosure is a non-transitory computer-readable recording medium having recorded thereon a program for causing a computer to perform the control method according to any one of the first aspect to the thirteenth aspect.

Note that these general and specific aspects may be implemented using a system, a device, an integrated circuit, a computer program, or a computer-readable recording medium such as CD-ROM, or any combination of systems, devices, integrated circuits, computer programs, and recording media.

Hereinafter, an embodiment will be described with reference to the drawings. Note that each embodiment described below shows one specific example of the present disclosure. The numerical values, shapes, materials, structural elements, the arrangement and connection of the structural elements, steps, the processing order of the steps, etc., shown in the following embodiment are mere examples, and are not intended to limit the present disclosure. Among the structural elements in the following embodiment, structural elements not recited in any one of the independent claims which indicate the broadest concepts are not necessarily required to achieve the object of the present disclosure, but are described as structural elements included in a more preferred embodiment.

### Embodiment

The present embodiment describes a control method in which, in a consortium blockchain with a plurality of participating organizations (a plurality of participating managers), when a first organization withdraws from said blockchain, said blockchain is deleted.

### Configuration

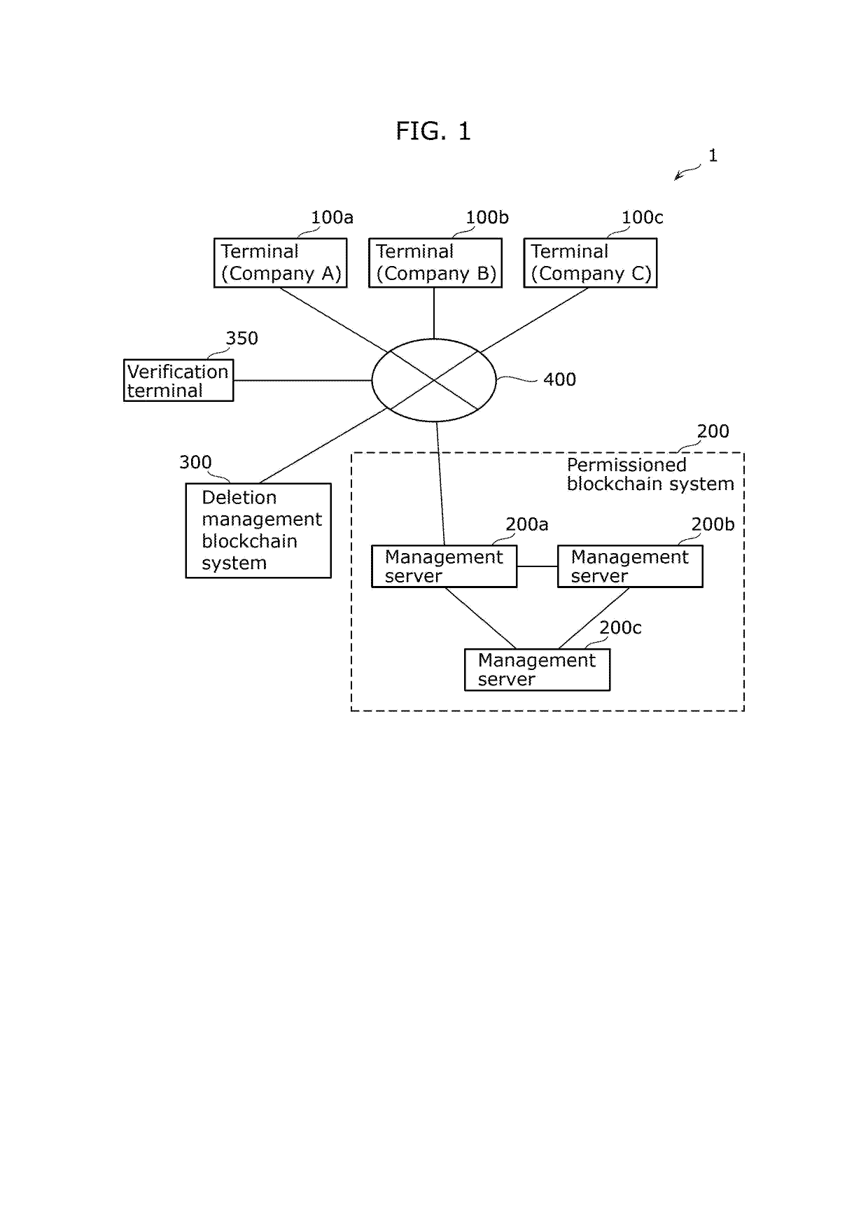

FIG. 1 is a block diagram illustrating an example of the configuration of a system according to the embodiment.

As illustrated in FIG. 1, system 1 includes terminals 100a to 100c, permissioned blockchain system 200, deletion management blockchain system 300, and verification terminal 350. Permissioned blockchain system 200 includes management servers 200a to 200c. Management servers 200a to 200c are a plurality of nodes constituting permissioned blockchain system 200. Permission blockchain system 200 is a consortium blockchain in which company A, company B, and company C participate. Company A, company B, and company C are an example of a plurality of organizations (the plurality of managers).

Deletion management blockchain system 300 includes a plurality of nodes. The plurality of nodes constituting deletion management blockchain system 300 may or may not include management servers 200a to 200c. The plurality of nodes constituting deletion management blockchain system 300 may include some of management servers 200a to 200c.

Terminals 100a to 100c, permissioned blockchain system 200, deletion management blockchain system 300, and verification terminal 350 may all be connected to each other by network 400, may all be directly connected to allow communication therebetween, or some of these elements may be connected by network 400 while some other elements are directly connected to allow communication therebetween. Network 400, which is the Internet or a cell-phone carrier network, for example, may include any communication line or network.

Terminal 100a is a terminal managed by company A. Specifically, terminal 100a is a terminal operated by user A who belongs to company A. Terminal 100a may present the processing result to user A.

Terminal 100b is a terminal managed by company B. Specifically, terminal 100b is a terminal operated by user B who belongs to company B. Terminal 100b may present the processing result to user B.

Terminal 100c is a terminal managed by company C. Specifically, terminal 100c is a terminal operated by user C who belongs to company C. Terminal 100c may present the processing result to user C.

Management server 200a may be managed by company A. Note that the functions of terminal 100a and management server 200a may be realized by a single device. In other words, management server 200a may include the functions of terminal 100a.

Management server 200b may be managed by company B. Note that the functions of terminal 100b and management server 200b may be realized by a single device. In other words, management server 200b may include the functions of terminal 100b.

Management server 200c may be managed by company C. Note that the functions of terminal 100c and management server 200c may be realized by a single device. In other words, management server 200c may include the functions of terminal 100c.

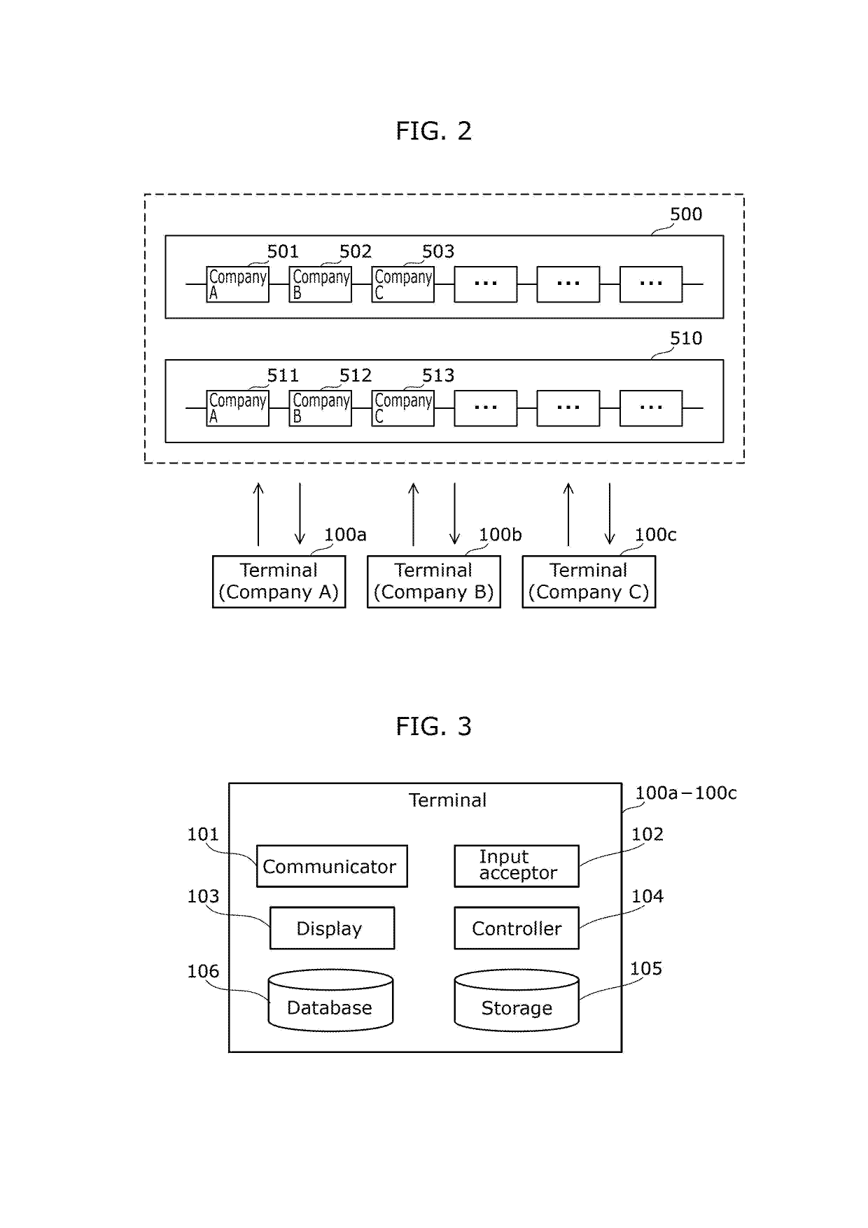

FIG. 2 is a conceptual diagram of the data structure of the blockchain managed by the permissioned blockchain system according to the embodiment.

Permissioned blockchain system 200 manages blockchains 500, 510. Specifically, management servers 200a to 200c manage blockchains 500, 510. Blockchain 500 includes block 501 including data for company A, block 502 including data for company B, and block 503 including data for company C. Blockchain 510 includes block 511 including data for company A, block 512 including data for company B, and block 513 including data for company C. Blockchains 500, 510 are accessed by each of terminals 100a to 100c to be used by retrieval of stored data or be used by storage of new data.

Note that the data stored in blockchain 500 and the data stored in blockchain 510 may be different. This means that blockchain 500 and blockchain 510 may be managed independently of each other.

In such blockchains 500, 510, if company C tries to delete all the blocks including data for company C from blockchains 500, 510 and deletes all the blocks including data for company C from management server 200c managed by company C, blockchains 500, 510 will still be maintained on management servers 200a, 200b managed by companies A, B. Therefore, the data for company C will not be deleted and will be left behind.

A conceivable solution involves, for example, first transferring the data for companies A, B to another device and then terminating all the functions of blockchains 500, 510 managed on management servers 200a to 200c to disable blockchains 500, 510, allowing the data for company C to be deleted from the network. In other words, a conceivable solution is to practically delete blockchains 500, 510 from the network by making blockchains 500, 510 inaccessible.

FIG. 3 is a diagram illustrating an example of the configuration of the terminal according to the embodiment.

Each of terminals 100a to 100c includes communicator 101, input acceptor 102, display 103, controller 104, and storage 105.

Communicator 101 may transmit information to other terminals included in terminals 100a to 100c or management servers 200a to 200c via the network and may receive information from other terminals or management servers 200a to 200c via the network. The other terminals refer to at least one of terminals 100a to 100c that is different from the terminal including said communicator 101.

In this manner, communicator 101 performs communication with other terminals or management servers 200a to 200c via the network. Note that this communication may be performed using transport layer security (TLS) and a cryptographic key for TLS communication may be held in communicator 101.

Input acceptor 102 accepts input from a user. Input acceptor 102 displays the accepted input on display 103, transmits the accepted input to controller 104, and transmits the accepted input to communicator 101, for example.

Display 103 displays a user interface (UI) that allows input acceptor 102 to accept input. Furthermore, display 103 displays, on the UI, the input accepted by input acceptor 102. Display 103 may display the information reported from management servers 200a to 200c.

Controller 104 generates transaction data on the basis of the information input accepted by input acceptor 102, and transmits the generated transaction data to management servers 200a to 200c via communicator 101.

Storage 105 stores the information received by communicator 101, the input accepted by input acceptor 102, and the transaction data generated by controller 104, for example. Storage 105 may store data other than said information.

Database 106 stores various kinds of information. Database 106 is managed by a corresponding manager (company A, company B, or company C). Database 106 may be designated as a transfer destination for data to be saved when the functions of blockchains are terminated. Database 106 is embodied using storage.

Terminals 100a to 100c can be realized by a processor executing a predetermined program using memory.

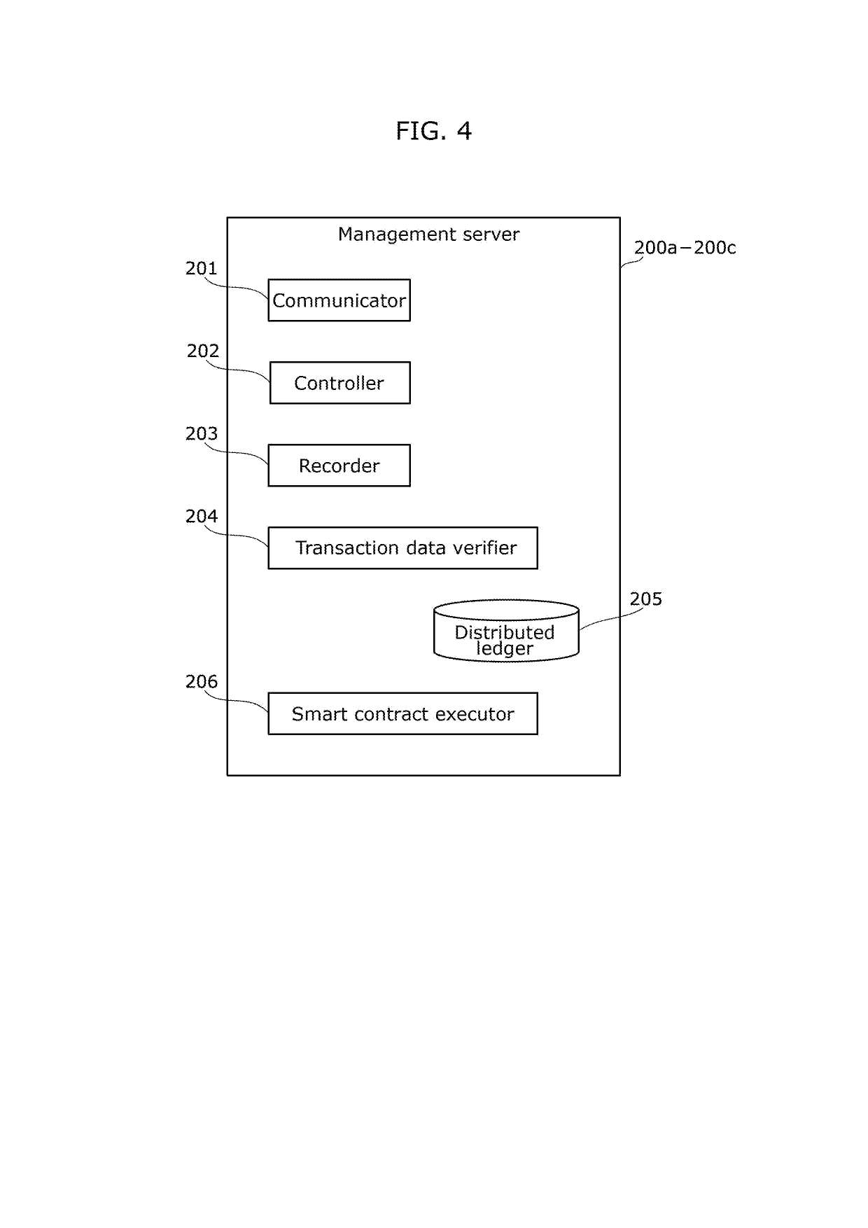

FIG. 4 is a diagram illustrating an example of the configuration of the management server according to the embodiment.

Each of management servers 200a to 200c includes communicator 201, controller 202, recorder 203, transaction data verifier 204, distributed ledger 205, and smart contract executor 206, as illustrated in FIG. 4. Each of management servers 200a to 200c is an example of a control device that manages one or more blockchains.

Communicator 201 transmits information to terminals 100a to 100c or other management servers included in management servers 200a to 200c via the network or receives information from terminals 100a to 100c or other management servers via the network, for example. The other management servers refer to at least one of management servers 200a to 200c that is different from the management server including said communicator 201. Furthermore, communicator 201 transmits and receives the transaction data to and from other management servers 200a to 200c.

In this manner, communicator 201 performs communication with terminals 100a to 100c or other management servers via the network. Note that this communication may be performed using transport layer security (TLS) and a cryptographic key for TLS communication may be held in communicator 201.

Controller 202 executes a consensus algorithm on the transaction data received by communicator 201. Thus, controller 202 stores said transaction data into distributed ledger 205. For example, controller 202 connects a block including the transaction data to the blockchain of distributed ledger 205 and thus stores, into the blockchain, the information included in said transaction data.

When communicator 201 receives transaction data, transaction data verifier 204 verifies the authenticity of said transaction data. For example, transaction data verifier 204 verifies whether an electronic signature generated in a proper method has been provided to the transaction data received by communicator 201. When the authenticity is verified, communicator 201 transmits a copy of the transaction data to a plurality of other management servers 200a to 200c, and thus the verified authentication transaction data is recorded in recorder 203 of each of other management servers 200a to 200c. Thus, only the transaction data whose authenticity has been verified is transmitted to other servers, which reduces the increase in power consumption of the computer. Note that this verification may be skipped.

Furthermore, together with the plurality of other management servers 200a to 200c, transaction data verifier 204 executes a consensus algorithm to agree on the authenticity of the transaction data.

As the consensus algorithm, practical byzantine fault tolerance (PBFT) may be used, or other known consensus algorithms may be used. Examples of the known consensus algorithms include proof of work (PoW) and proof of stake (PoS). When the PBFT is used as the consensus algorithm, transaction data verifier 204 receives, from each of the plurality of management servers 200a to 200c, a report indicating whether the verification of the transaction data has been successful, and determines whether the number of said reports exceeds a predetermined number. It is sufficient that when the number of said reports exceeds the predetermined number, transaction data verifier 204 determine that the authenticity of the transaction data has been verified using the consensus algorithm.

When transaction data verifier 204 confirms the authenticity of the transaction data, transaction data verifier 204 causes recorder 203 to record said transaction data. When the authenticity of the transaction data is not verified, transaction data verifier 204 discards the transaction data. As a result, the transaction data whose authenticity is not verified is not recorded into recorder 203; therefore, the required amount of computer resources can be reduced. Transaction data verifier 204 may generate a block including the transaction data whose authenticity has been confirmed and store the generated block into distributed ledger 205.

In the present embodiment, transaction data verifier 204 verifies the authenticity of the transaction data received by communicator 201.

Note that recorder 203 stores, into distributed ledger 205, the transaction data whose authenticity has been verified by transaction data verifier 204, thereby recording the transaction data. Thus, the transaction data can be protected from tampering.

Note that recorder 203 may be formed inside distributed ledger 205.

In distributed ledger 205, transaction data is stored. Since distributed ledger 205 sequentially obtains and stores transaction data, transaction data for one or more transactions is stored in distributed ledger 205. Distributed ledger 205 is embodied using storage.

Smart contract executor 206 operates the smart contract by executing a contract code, etc., included in the transaction data stored in the blockchain of distributed ledger 205.

In this manner, by operating smart contracts, smart contract executor 206 can manage various processes using distributed ledger 205. Note that the smart contracts are generated using applications on management servers 200a to 200c or terminals 100a to 100c on the basis of operations performed by users, for example, and blocks including the smart contracts have been stored in blockchains in advance. This means that the contract codes of the smart contracts are stored in blockchains.

Note that the contract codes of the smart contracts may be separately stored in the blockchains or may be stored in the blockchains as one integrated contract code.

### Operation

Next, the operation of system 1 configured as described above will be described.

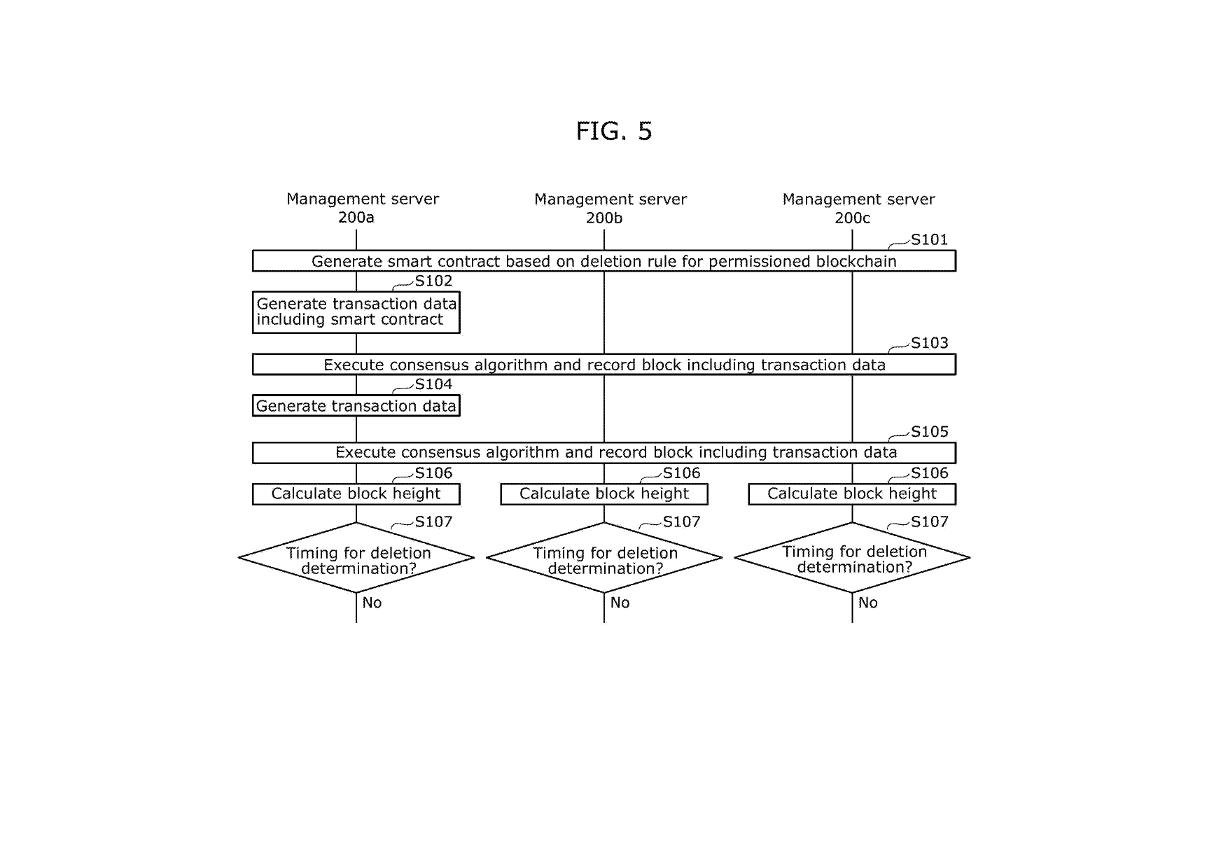

FIG. 5 is a sequence chart illustrating a first portion of an example of the operation of the system according to the embodiment.

Management servers 200a to 200c generate a smart contract based on a deletion rule for the permissioned blockchain (S101). Step S101 may be performed by all of management servers 200a to 200c or may be performed by at least one of management servers 200a to 200c.

The smart contract includes a first smart contract for determining whether to delete blockchain 500 among the plurality of blockchains 500, 510. This determination is performed based on a first rule. The first rule is for deleting a first blockchain that has satisfied a first condition when the first condition is satisfied. The first condition is that the data size or processing load-related parameter of the first blockchain exceeds a first threshold value. The data size-related parameter is, for example, the data size of the whole first blockchain (the data stored in distributed ledger 205) or the block height of the first blockchain (the total number of blocks included in the blockchain). The processing load-related parameter is, for example, the amount of processing related to block generation in the blockchain or CO₂ emissions in the processes for managing the blockchain.

Management server 200a generates transaction data including the generated smart contract (S102). Step S102 may be performed by one of management servers 200b, 200c or may be performed by management servers 200a to 200c. Management server 200a transfers the transaction data generated in Step S102 to other management servers 200b, 200c, and thus management servers 200a to 200c execute the consensus algorithm and record a block including the transaction data into the blockchain (S103). As a result, the transaction data including the smart contract is stored into distributed ledger 205.

Steps S101 to S103 are processes for generating a smart contract and storing the smart contract into the blockchain. Thereafter, management servers 200a to 200c perform normal blockchain operations.

For example, management server 200a generates transaction data including data to be recorded in the blockchain (S104), and transfers the generated transaction data to management servers 200b, 200c.

Thus, management servers 200a to 200c execute a consensus algorithm and record a block including the transaction data generated in Step S104 into the blockchain (S105).

Next, management servers 200a to 200c calculate the block height of the blockchain (S106). For example, management servers 200a to 200c may calculate the block height by counting the total number of blocks included in the blockchain or may calculate the block height by adding 1 to the block height recorded in the memory each time one block is added to the blockchain.

Management servers 200a to 200c determine whether the timing for deletion determination has been reached (S107). The timing for deletion determination refers to the timing when a determination is performed to delete a blockchain under management. For example, when the calculated block height exceeds a first value (for example, 100), management servers 200a to 200c may determine that the timing for deletion determination has been reached. In this case, when the block height does not exceed the first value, management servers 200a to 200c determine that the timing for deletion determination has not been reached and thus, continue the normal blockchain operations. FIG. 5 exemplifies the case where it is determined that the timing for deletion determination has not been reached.

Steps S106 and S107 may be performed according to a smart contract. Specifically, this smart contract is executed every time the transaction data is received in the normal blockchain operations. This smart contract may be included in the smart contract generated in Step S101.

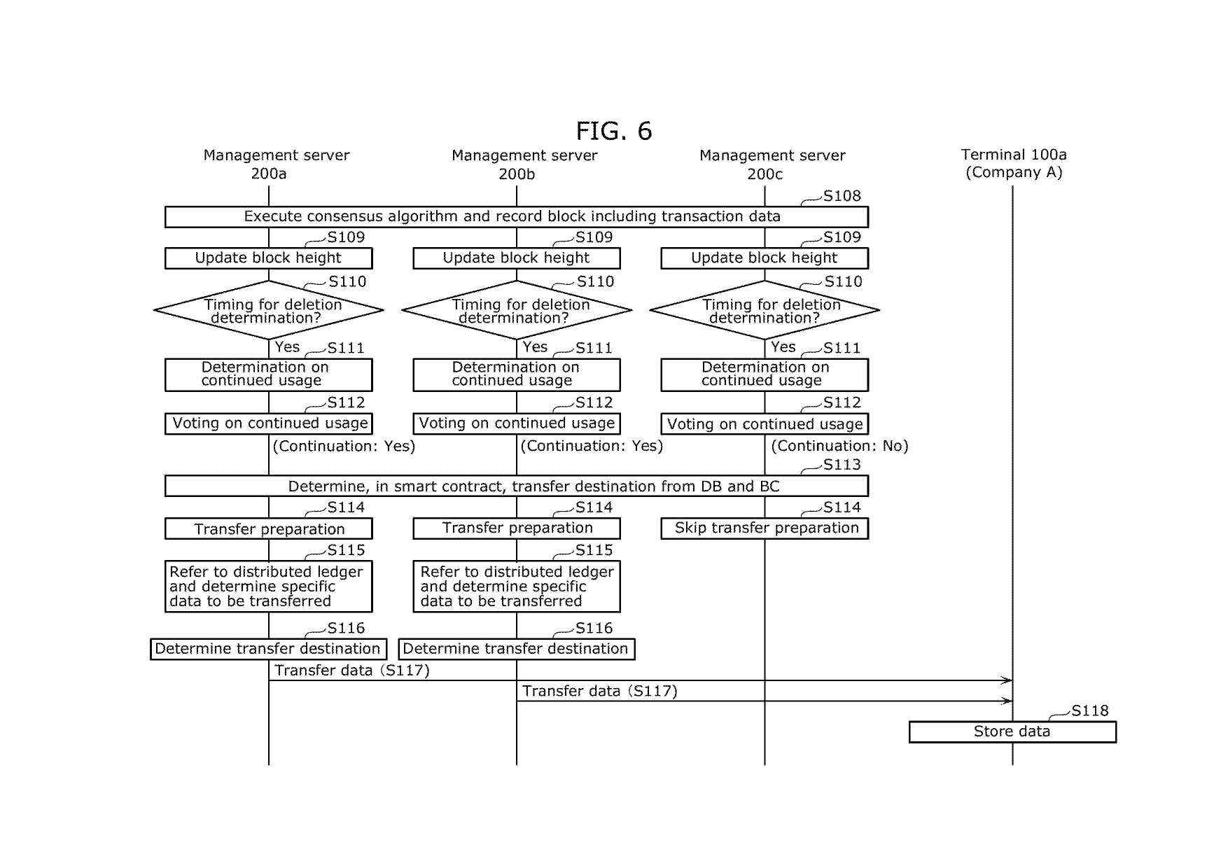

FIG. 6 is a sequence chart illustrating a second portion of an example of the operation of the system according to the embodiment. The second portion represents the processing that follows the first portion.

Since it is determined that the timing for deletion determination has not been reached (No in Step S107), the normal blockchain operations continue. Therefore, Steps S108 to S110 are performed on different transaction data. Steps S108 to S110 are the same processes as Steps S105 to S107 except that target transaction data is different. As such, detailed description thereof will be omitted.

Assume that the block height is determined to have exceeded the first value in Step S110. Since it is determined that the timing for deletion determination has been reached (Yes in Step S110), management servers 200a to 200c determine whether to continue using the blockchain (S111).

Management servers 200a to 200c determine by vote whether to continue using the blockchain (S112). The example in FIG. 6 shows that management server 200a managed by company A and management server 200b managed by company B have voted to express the intent to continue using the blockchain, while management server 200c managed by company C has voted to express the intent to discontinue using the blockchain (voted to express the intent to withdraw from the blockchain).

Next, management servers 200a to 200c determine, in the smart contract, a transfer destination for specific data included in the data for companies A, B that have expressed the intent to continue the usage, from a database managed by company A or B and another blockchain (S113). The database designated as the transfer destination may be a database managed by company A or B that has expressed the intent to continue the usage or may be a database managed by another company or organization, for example. For example, when the number of remaining organizations excluding company C that has determined to withdraw among companies A, B, C, which are the plurality of organizations, is greater than or equal to a sixth threshold value, management servers 200a to 200c determine, as a predetermined device that is the transfer destination, a device that manages another blockchain different from the blockchains managed by management servers 200a to 200c. In this case, management servers 200a to 200c determine the transfer destination to be another blockchain. On the other hand, when the number of remaining organizations is less than the sixth threshold value, management servers 200a to 200c determine, as a predetermined device that is the transfer destination, a device in which the database is stored. In this case, management servers 200a to 200c determine the transfer destination to be a device including the database managed by company A or B that has expressed the intent to continue the usage (for example, terminal 100a or terminal 100b). In this example, the sixth threshold value is 3. Note that the sixth threshold value may be an integer other than 3 as long as the sixth threshold value is an integer greater than or equal to 2.

Next, among management servers 200a to 200c, management servers 200a, 200b corresponding to companies A, B that have expressed the intent to continue the usage prepare to transfer the specific data, and management server 200c corresponding to company C that has not expressed the intent to continue the usage skips the specific data transfer preparation (S114).

Next, each of management servers 200a, 200b corresponding to companies A, B that have expressed the intent to continue the usage refers to distributed ledger 205 included in the corresponding management server and determines the specific data to be transferred (S115).

Note that the specific data to be transferred may be determined based on a second rule. The second rule determines that data with a specific attribute, among data on all the blockchains managed by management servers 200a to 200c, is the specific data to be transferred. The specific data may be data including, as an attribute, the identification information of company A or B that has expressed the intent to continue using the blockchain or may be data including a different specific attribute as an attribute. The identification information may be included in the data as a transmission destination or may be included in the data as a transmission source. The specific attribute may be determined in advance by companies A, B, and C. The specific attribute may have been associated with data included in all the blockchains.

The different specific attribute may be the identification information of a device other than a device with a discontinued model number. Specifically, the specific data may be a log associated with the identification information of a device other than a device with a discontinued model number. The different specific attribute may be a wallet address. Specifically, the specific data may be data associated with a predetermined wallet address. Furthermore, the specific attribute may be information indicating a specific organization, information indicating a specific user, or information indicating a specific device.

The specific data may be determined according to a smart contract. The smart contract for determining the specific data may be included in the smart contract generated in Step S101.

Next, management servers 200a, 200b determine the transfer destination to be the predetermined device (S116). When the transfer destination is determined to be another blockchain based on the result of Step S113, management servers 200a, 200b determine, as the predetermined device, a plurality of management servers that manage the other blockchain. When the transfer destination is determined to be a database based on the result of Step S113, management servers 200a, 200b determine, as the predetermined device, one of terminal 100a of company A and terminal 100b of company B, based on a predetermined rule. The predetermined rule stipulates the order of preference of companies A, B, and C. Management servers 200a, 200b determine, as the predetermined device, a terminal corresponding to an organization with the high preference in the predetermined rule. Note that the predetermined rule may stipulate the order of preference based on corporate management indicators. The corporate management indicators are indicators based on the business rating, the compliance with the international organization for standardization (ISO), or the compliance with the privacy mark, for example. Furthermore, the predetermined rule may stipulate the order of preference based on the indicator of the database or the blockchain. The indicator of the database or the blockchain is an indicator based on quality (OSS maintenance, license, security check, and blockchain decentralization), price (the store’s cost for the database and the maintenance cost of the blockchain network), or performance (I/O speed).

The predetermined device may be determined according to a smart contract. The smart contract for determining the predetermined device may be included in the smart contract generated in Step S101. The example in FIG. 6 shows that terminal 100a has been determined as the predetermined device.

Since terminal 100a has been determined as the predetermined device, management servers 200a, 200b transfer the specific data to terminal 100a (S117).

Note that the predetermined device may be management servers 200a, 200b. In this case, management servers 200a, 200b may generate a new blockchain different from blockchains 500, 510 and store the specific data into the new blockchain. In this case, management servers 200a, 200b may generate the new blockchain together with other management servers.

Furthermore, the predetermined device may be determined in advance. In other words, Step S113 does not need to be performed, and the predetermined device may be determined based on a predetermined rule.

Terminal 100a to which the specific data has been transferred stores the specific data transferred thereto (S118).

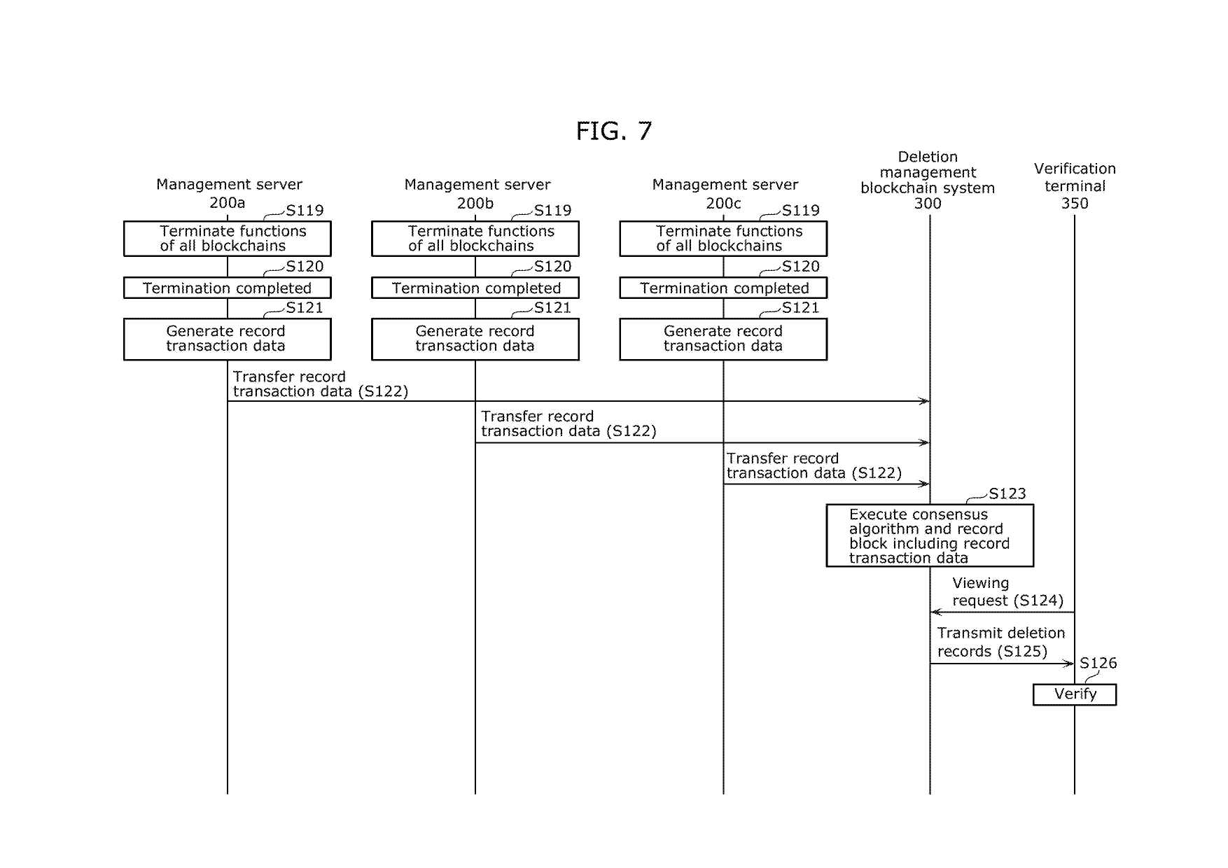

FIG. 7 is a sequence chart illustrating a third portion of an example of the operation of the system according to the embodiment. The third portion represents the processing that follows the second portion.

When the transfer of the specific data is completed, management servers 200a to 200c delete distributed ledger 205 (S119). Specifically, management servers 200a to 200c terminate the functions of all the blockchains managed by management servers 200a to 200c. In the termination of the functions of all the blockchains, the synchronization between management servers 200a to 200c is terminated, the update of local distributed ledger 205 is terminated, the communication related to the blockchains is terminated, and the processes related to the blockchains are terminated, for example. Furthermore, in the termination of the functions of all the blockchains, the data included in local distributed ledger 205 may be deleted, and distributed ledger 205 may be physically deleted.

When the termination of the functions of all the blockchains is completed (S120), in order to record information indicating that the termination of the functions of all the blockchains is completed, management servers 200a to 200c generate record transaction data including said information (S121).

Management servers 200a to 200c transfer the generated record transaction data to deletion management blockchain system 300 (S122).

When deletion management blockchain system 300 receives the record transaction data, deletion management blockchain system 300 executes a consensus algorithm between a plurality of nodes included in deletion management blockchain system 300, and records a block including the record transaction data (S123).

Verification terminal 350 transmits a viewing request for viewing deletion records that are data within the blockchain managed by deletion management blockchain system 300 (S124). In response to the viewing request, deletion management blockchain system 300 transmits deletion records to verification terminal 350 (S125). Thus, by referring to the deletion records, verification terminal 350 can verify that all the blockchains managed by management servers 200a to 200c have been deleted (S126).

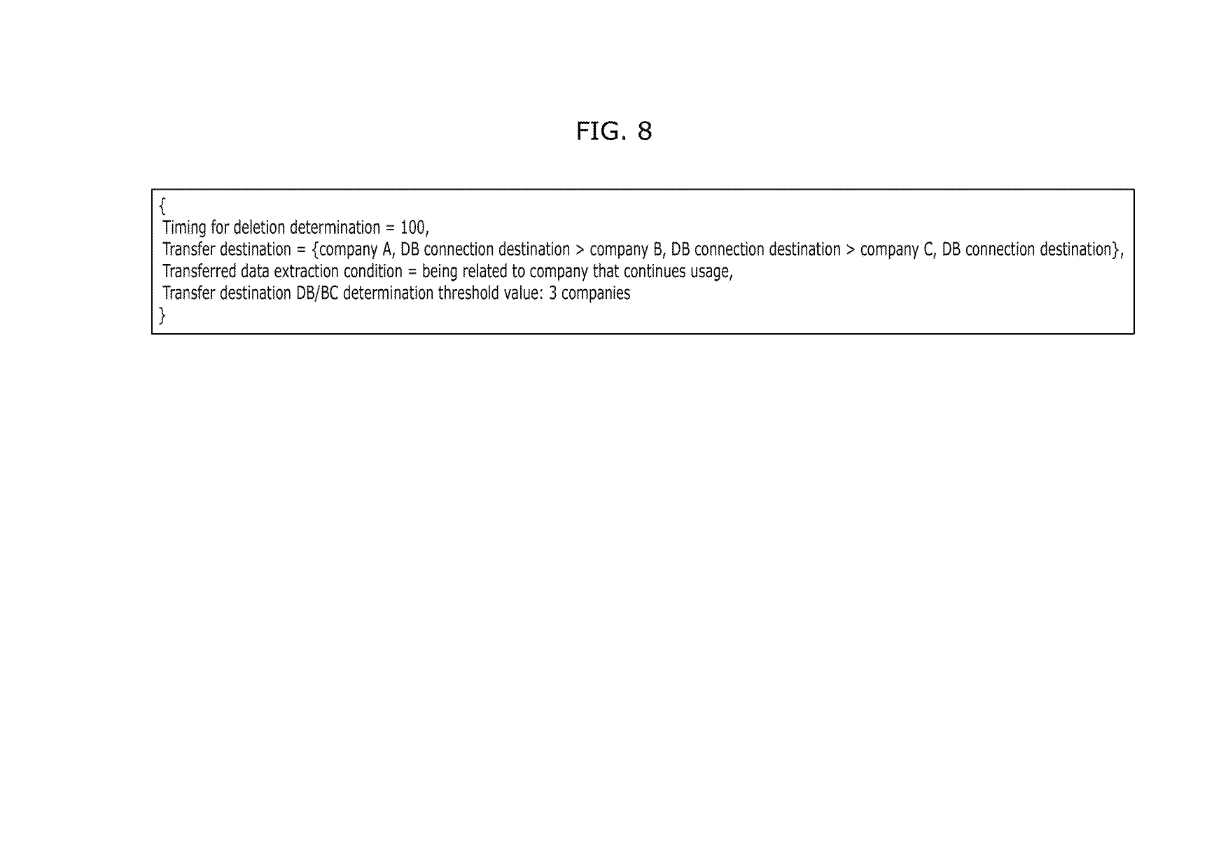

FIG. 8 is a diagram illustrating an example of the smart contract according to the embodiment.

As illustrated in FIG. 8, the smart contract may include, for example, the timing for deletion determination, the order of preference for determining the transfer destination, the condition for extracting the transferred data (the specific data), and the sixth threshold value for determining the transfer destination from another blockchain and a database.

### Advantageous Effects, etc.

A control method according to the present embodiment is a control method to be performed by management server 200a (a control device) that manages one or more blockchains and includes: determining, based on a first rule, whether to delete one or more first blockchains including first data among the one or more blockchains; and when the one or more first blockchains are determined to be deleted, terminating, at a predetermined timing, functions of the one or more first blockchains including the first data among the one or more blockchains managed by management server 200a.

Thus, when it is determined that the one or more first blockchains are to be deleted, management server 200a terminates the functions of all the blockchains under management, and the data to be deleted can be practically deleted from the network.

Furthermore, by deleting distributed ledger 205 that contains unnecessary data, management server 200a can eliminate the storage capacity for storing unnecessary data.

Furthermore, the control method according to the present embodiment further includes: generating first transaction data including a first smart contract for the determining; and storing the first transaction data into the one or more blockchains. The determining is performed according to the first smart contract.

Thus, whether to delete the one or more first blockchains is determined according to the first smart contract, meaning that the determination based on the first rule can be automatically performed. Furthermore, since the contract code of the first smart contract is stored in the one or more blockchains and open to the public, the logic in deleting the one or more first blockchains can be verified. Therefore, the fairness of the determination can be ensured.

Furthermore, in the control method according to the present embodiment, the first rule is to delete the one or more first blockchains when a first condition is satisfied. The first condition is that the data size or processing load-related parameter of the one or more first blockchains exceeds a first threshold value.

Accordingly, it is possible to delete a blockchain whose data size or processing load-related parameter exceeds the first threshold value.

Furthermore, in the control method according to the present embodiment, the determining is performed when a second condition is satisfied. The second condition is that the data size or processing load-related parameter of the one or more first blockchains exceeds a second threshold value.

Accordingly, whether to delete the one or more first blockchains can be determined at the timing when the data size or processing load-related parameter exceeds the second threshold value.

Furthermore, in the control method according to the present embodiment, the predetermined timing occurs when a third condition is satisfied. The third condition is that the data size or processing load-related parameter of the one or more first blockchains exceeds a third threshold value.

Accordingly, the functions of all the blockchains managed by the control device can be terminated at the timing when the data size or processing load-related parameter exceeds the third threshold value.

Furthermore, the control method according to the present embodiment further includes: determining specific data from the one or more blockchains based on a second rule; and transferring the specific data to a predetermined device before the predetermined timing. The second rule is to determine data with a specific attribute as the specific data.

Thus, among data that becomes unavailable on blockchains when the functions of the one or more blockchains are terminated, the specific data to be saved is transferred to the predetermined device, meaning that even when the functions of the one or more blockchains are terminated, the specific data can be used.

Furthermore, in the control method according to the present embodiment, the predetermined device determined as a transfer destination controls another blockchain different from the one or more blockchains. The specific data transferred is stored into the other blockchain.

Thus, among data that becomes unavailable on blockchains when the functions of the one or more blockchains are terminated, the specific data to be saved is stored into another blockchain, meaning that even when the functions of the one or more blockchains are terminated, the specific data can be used by accessing the other blockchain.

Furthermore, in the control method according to the present embodiment, a total number of a plurality of nodes that control the other blockchain is greater than or equal to a fourth threshold value or a block height of the other blockchain is greater than or equal to a fifth threshold value.

Accordingly, a blockchain with higher reliability can be determined as the transfer destination.

Furthermore, in the control method according to the present embodiment, a database is stored in the predetermined device. The specific data transferred is stored into the database.

Thus, among data that becomes unavailable on blockchains when the functions of the one or more blockchains are terminated, the specific data to be saved is stored into a database, meaning that even when the functions of the one or more blockchains are terminated, the specific data can be used by accessing the database.

Furthermore, in the control method according to the present embodiment, each of the one or more blockchains is a consortium blockchain in which a plurality of organizations participate. Each of the one or more first blockchains is a blockchain determined to be deleted for a first organization among the plurality of organizations to withdraw from the one or more blockchains. When a total number of remaining organizations excluding the first organization among the plurality of organizations is greater than or equal to a sixth threshold value, a device that manages another blockchain different from the one or more blockchains is determined as the predetermined device. When the total number of remaining organizations is less than the sixth threshold value, a device in which a database is stored is determined as the predetermined device.

Accordingly, when the total number of organizations is greater than or equal to the sixth threshold value, the specific data is stored into another blockchain, which allows the specific data to be continuously managed on a consortium blockchain. When the total number of organizations is less than the sixth threshold value, the specific data is stored into a database, which allows the specific data to be managed in the database.

Furthermore, the control method according to the present embodiment further includes: generating second transaction data including a second smart contract for the determining of the specific data; and storing the second transaction data into the one or more blockchains. The determining of the specific data is performed according to the second smart contract.

Thus, the specific data can be automatically determined according to the second smart contract. Furthermore, since the contract code of the second smart contract is stored in the one or more blockchains and open to the public, the logic in determining the specific data can be verified.

Furthermore, the control method according to the present embodiment further includes: generating third transaction data including a third smart contract for the determining of the predetermined device; and storing the third transaction data into the one or more blockchains. The predetermined device is determined by executing the third smart contract.

Thus, the predetermined device can be automatically determined according to the third smart contract. Furthermore, since the contract code of the third smart contract is stored in the one or more blockchains and open to the public, the logic in determining the predetermined device can be verified.

Furthermore, the control method according to the present embodiment further includes: after the terminating, recording information indicating that functions of the one or more blockchains have been terminated; and storing the information into a blockchain for records that is different from the one or more blockchains.

When the functions of the one or more blockchains are terminated, the functions of the one or more blockchains cannot be used. Therefore, the information indicating that the functions of the one or more blockchains have been terminated is stored into the blockchain for records, which allows reference to the fact that the functions of the one or more blockchains have been terminated.

### Variations

(1) The control method according to the above embodiment is intended for a consortium blockchain, but a consortium blockchain is not the only option; the control method according to the above embodiment may be applied to a public blockchain or may be applied to a private blockchain.

(2) In system 1 according to the above embodiment, the plurality of blockchains 500, 510 are managed; however, the number of blockchains under management may be three or more or may be one. In other words, it is sufficient that system 1 manage one or more blockchains.

(3) In the control method according to the above embodiment, the timing for deletion determination is determined based on the block height, but this is not limiting. The timing for deletion determination may be determined based on the data size-related parameter or may be determined based on the processing load-related parameter. It is sufficient that the determination of the timing for deletion determination be the determination of whether the second condition has been satisfied. The second condition is that the data size or processing load-related parameter of the one or more first blockchains exceeds the second threshold value.

(4) In voting on whether to continue the usage in the control method according to the above embodiment, a weighted scoring rule may be used. For example, the voting score may be changed for each organization. The weighted score may be hard-coded.

(5) The voting on whether to continue the usage in the control method according to the above embodiment has been described thus far assuming that each organization has the right to vote, but this is not limiting; a node included in a blockchain may have the right to vote.

### Additional Comments

The following are additional comments on the distributed ledger according to the embodiment or the variations described above. A blockchain will be described herein as an example of the distributed ledger; the same is true for other distributed ledgers.

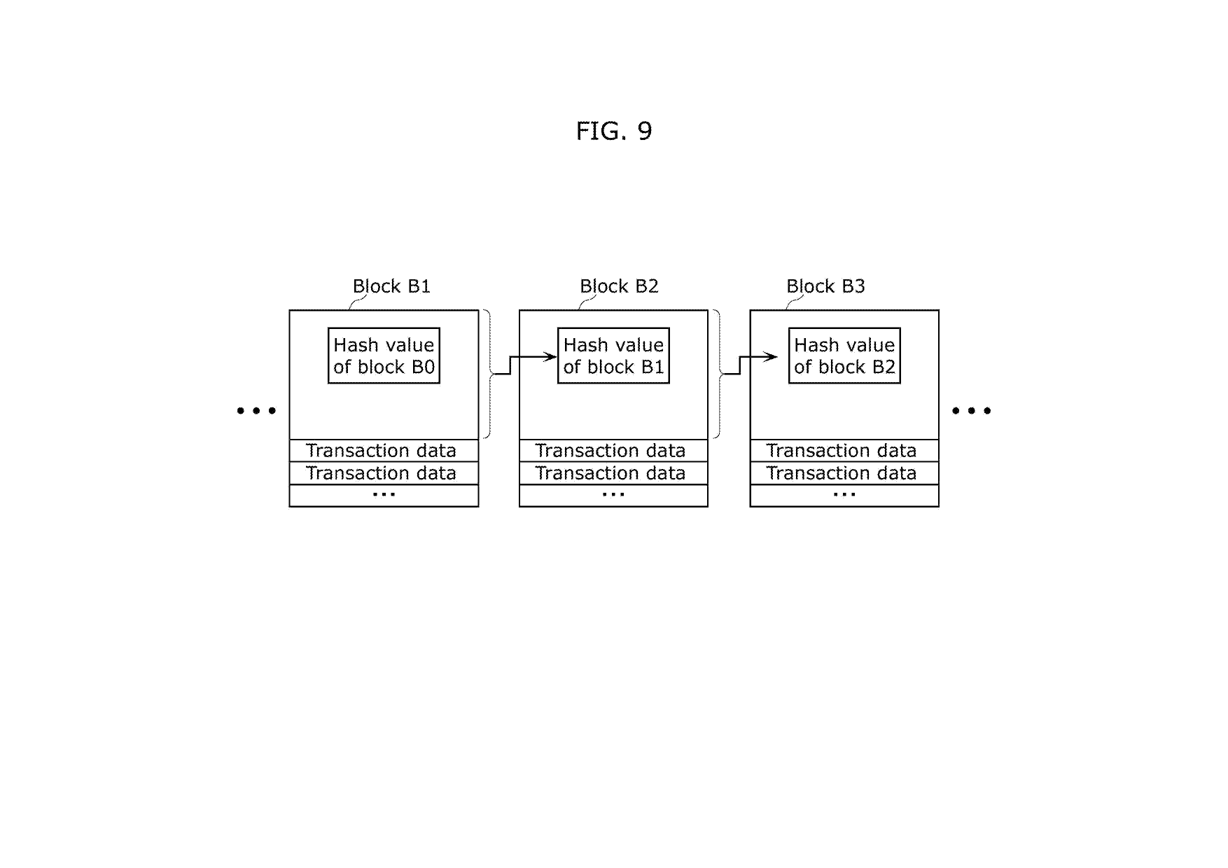

FIG. 9 is an explanatory diagram illustrating the data structure of a blockchain.

The blockchain is made up of blocks, each of which is a recording unit of the blockchain, linked together in the form of a chain. Each of the blocks includes a plurality of items of transaction data and a hash value of an immediately preceding block. Specifically, block B2 includes the hash value of previous block B1. Furthermore, a hash value calculated using the hash value of block B1 and the plurality of items of transaction data included in block B2 is included in block B3 as the hash value of block B2. In this manner, blocks are linked together in the form of a chain while including the content of previous blocks as hash values; thus, the recorded transaction data is effectively prevented from being tempered with.

If previous transaction data is changed, the hash value of the block becomes different from the original value, meaning that in order to make the block tampered with look correct, all the subsequent blocks need to be recreated, which is an extremely difficult task in practice. Using this feature, it is ensured that the blockchain is tamper-proof.

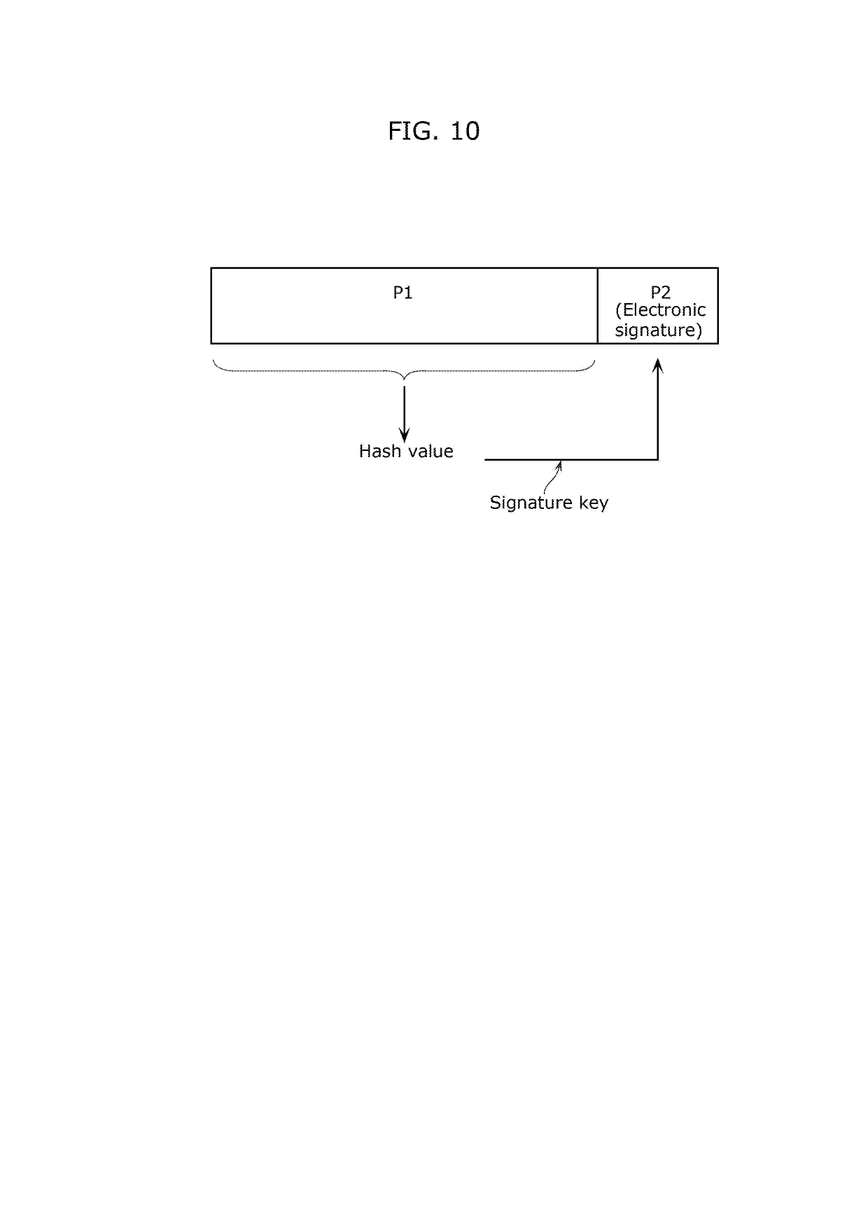

FIG. 10 is an explanatory diagram illustrating the data structure of transaction data.

The transaction data illustrated in FIG. 10 includes transaction body P1 and digital signature P2. Transaction body P1 is a data body included in said transaction data. Digital signature P2 is generated for the hash value of transaction body P1 by using a signature key of a creator of said transaction data; more specifically, digital signature P2 is generated by encrypting said hash value with a private key of the creator of said transaction data. Examples of the type of the digital signature include the elliptic curve digital signature algorithm (ECDSA), CRYSTALS-Dilithium, Falcon, and SPHINCS+.

Because of including digital signature P2, the transaction data is virtually impossible to tamper with. This is because tampering with the transaction data will result in unsuccessful verification using digital signature P2, which reveals that the transaction data has been tampered with. Thus, transaction body P1 is protected from tampering.

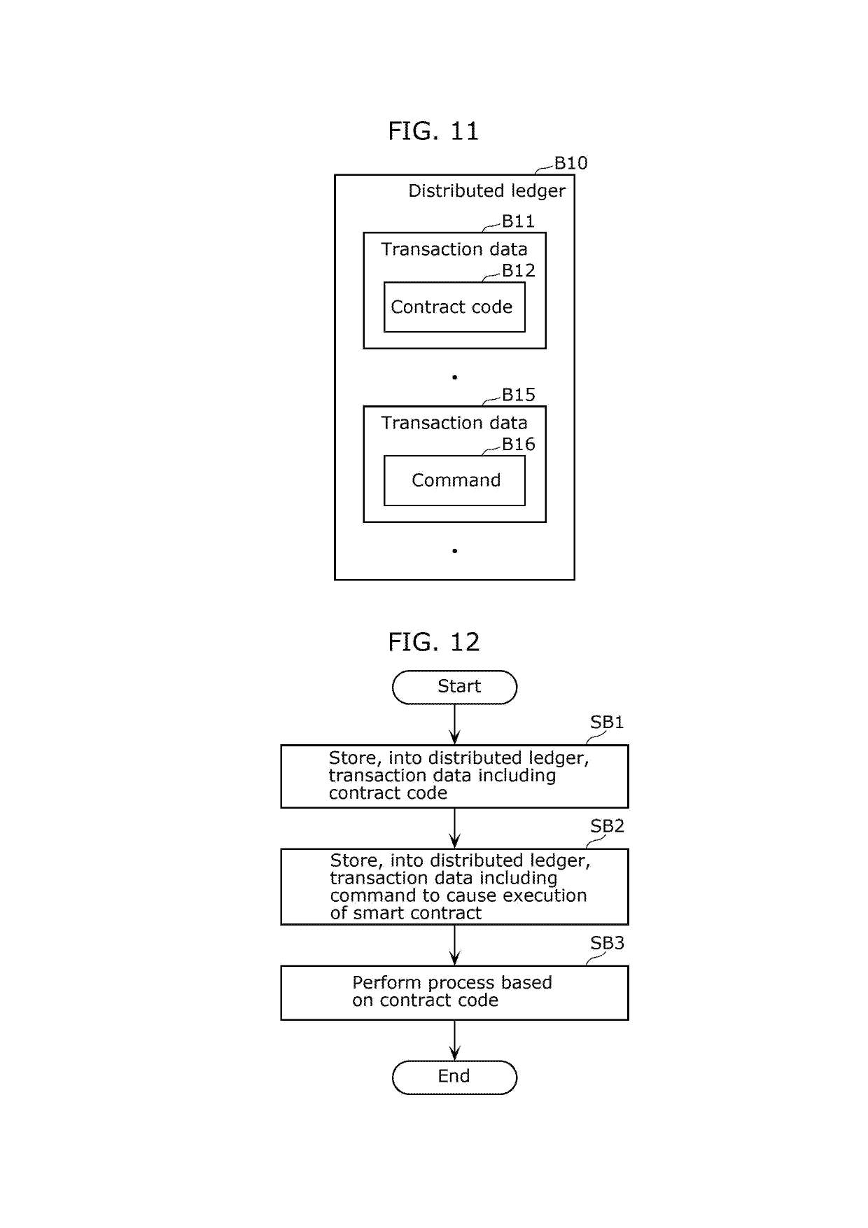

FIG. 11 is an explanatory diagram illustrating transaction data related to execution of a smart contract. FIG. 12 is an explanatory diagram illustrating processing related to execution of a smart contract.

With reference to FIG. 11 and FIG. 12, a series of processes related to the execution of the smart contract using the distributed ledger will be described.

In Step SB1, a node stores, into distributed ledger B10, transaction data B11 including contract code B12 in which the processing of the smart contract is written. For example, the node receives transaction data B11 from an information processing device via communication or the node itself generates transaction data B11 and thus, the node obtains transaction data B11, and stores obtained transaction data B11 into distributed ledger B10. Step SB1 is performed before the smart contract is executed.

In Step SB2, the node stores, into distributed ledger B10, transaction data B15 including command B16 to cause the execution of the smart contract. For example, the node receives transaction data B15 from an information processing device via communication and stores received transaction data B15 into distributed ledger B10.

In Step SB3, the node reads contract code B12 from distributed ledger B10 as a result of transaction data B15 including command B16 being stored into distributed ledger B10 in Step SB2, and performs a process based on contract code B12. The result of said process may be included in the transaction data and stored into distributed ledger B10.

When the distributed ledger system receives transaction data B15 including command B16 to cause the execution of the smart contract, the distributed ledger system automatically (in other words, without manual intervention) performs processes that follow command B16 by the above-described series of processes and can therefore perform the processes efficiently (in other words, at high speed or in a short time). Realization of the efficient processes results in the effect of reduced power consumption. Furthermore, since there is no manual intervention, tampering with information by a person, a fraudulent act, or a human error can be prevented. Moreover, since the result of the processes performed in this manner is stored into the blockchain, the result of the processes can be virtually impossible to tamper with.

Note that in the above-described embodiment or variations, each of the structural elements may be configured in the form of an exclusive hardware product, or may be realized by executing a software program suitable for the structural element. Each of the structural elements may be realized by means of a program executing unit, such as a CPU or a processor, reading and executing the software program recorded on a recording medium such as a hard disk or semiconductor memory. Here, the software program for realizing the control device or the like according to each of the embodiment and the variations described above is a program described below.

Specifically, this program causes a computer to perform a control method that is performed by a control device that manages one or more blockchains, and includes: determining, based on a first rule, whether to delete one or more first blockchains including first data among the one or more blockchains; and when the one or more first blockchains are determined to be deleted, terminating, at a predetermined timing, functions of the one or more first blockchains including the first data among the one or more blockchains managed by the control device.

The control device or the like according to one or more aspects has been described thus far based on the embodiment, but the present disclosure is not limited to this embodiment. Various modifications to the present embodiment and forms configured by combining structural elements in different embodiments that can be conceived by those skilled in the art may be included within the scope of one or more aspects as long as these do not depart from the essence of the present disclosure.

### Industrial Applicability

The present disclosure is useful as a control method, etc., in which the data to be deleted can be deleted without being left behind on a blockchain.

1. A control method to be performed by a control device that manages one or more blockchains, the control method comprising:
determining, based on a first rule, whether to delete one or more first blockchains including first data among the one or more blockchains; and
when the one or more first blockchains are determined to be deleted, terminating, at a predetermined timing, functions of the one or more first blockchains including the first data among the one or more blockchains managed by the control device.

2. The control method according to claim 1, further comprising:
generating first transaction data including a first smart contract for the determining; and
storing the first transaction data into the one or more blockchains, wherein
the determining is performed according to the first smart contract.

3. The control method according to claim 1, wherein
the first rule is to delete the one or more first blockchains when a first condition is satisfied, the first condition being that a data size or processing load-related parameter of the one or more first blockchains exceeds a first threshold value.

4. The control method according to claim 2, wherein
the determining is performed when a second condition is satisfied, the second condition being that a data size or processing load-related parameter of the one or more first blockchains exceeds a second threshold value.

5. The control method according to claim 1, wherein
the predetermined timing occurs when a third condition is satisfied, the third condition being that a data size or processing load-related parameter of the one or more first blockchains exceeds a third threshold value.

6. The control method according to claim 1, further comprising:
determining specific data from the one or more blockchains based on a second rule; and
transferring the specific data to a predetermined device before the predetermined timing, wherein
the second rule is to determine data with a specific attribute as the specific data.

7. The control method according to claim 6, wherein
the predetermined device controls another blockchain different from the one or more blockchains, and
the specific data transferred is stored into the other blockchain.

8. The control method according to claim 7, wherein
a total number of a plurality of nodes that control the other blockchain is greater than or equal to a fourth threshold value or a block height of the other blockchain is greater than or equal to a fifth threshold value.

9. The control method according to claim 6, wherein
a database is stored in the predetermined device, and
the specific data transferred is stored into the database.

10. The control method according to claim 6, wherein
each of the one or more blockchains is a consortium blockchain in which a plurality of organizations participate,
each of the one or more first blockchains is a blockchain determined to be deleted for a first organization among the plurality of organizations to withdraw from the one or more blockchains,
when a total number of remaining organizations excluding the first organization among the plurality of organizations is greater than or equal to a sixth threshold value, a device that manages another blockchain different from the one or more blockchains is determined as the predetermined device, and
when the total number of remaining organizations is less than the sixth threshold value, a device in which a database is stored is determined as the predetermined device.

11. The control method according to claim 6, further comprising:
generating second transaction data including a second smart contract for the determining of the specific data; and
storing the second transaction data into the one or more blockchains, wherein
the determining of the specific data is performed according to the second smart contract.

12. The control method according to claim 6, further comprising:
generating third transaction data including a third smart contract for the determining of the predetermined device; and
storing the third transaction data into the one or more blockchains, wherein
the predetermined device is determined by executing the third smart contract.

13. The control method according to claim 1, further comprising:
after the terminating, recording information indicating that functions of the one or more blockchains have been terminated; and
storing the information into a blockchain for records that is different from the one or more blockchains.

14. A system including a control device that manages one or more blockchains, the system comprising:
a processor; and
memory, wherein
using the memory, the processor:
determines, based on a first rule, whether to delete one or more first blockchains including first data among the one or more blockchains; and
when the one or more first blockchains are determined to be deleted, terminates, at a predetermined timing, functions of the one or more first blockchains including the first data among the one or more blockchains managed by the control device.

15. A non-transitory computer-readable recording medium having recorded thereon a program for causing a computer to perform the control method according to claim 1.
